(19) United States
(12) Patent Application Publication
(10) Pub. No.: US 2024/0334902 A1
(43) Pub. Date: Oct. 10, 2024

(54) TRACKING SYSTEM AND METHOD FOR ANIMAL RACING AND/OR TRAINING

(71) Applicant: TRIPLESDATA PTY LTD, Frenchs Forest NSW (AU)

(72) Inventor: Sebastian SCHOLZ, Frenchs Forest NSW (AU)

(73) Assignee: TRIPLESDATA PTY LTD, Frenchs Forest NSW (AU)

(21) Appl. No.: 18/682,026

(22) PCT Filed: Aug. 16, 2022
(86) PCT No.: PCT/AU2022/050895

§ 371 Date: Feb. 7, 2024

(30) Foreign Application Priority Data
Aug. 16, 2021 (AU) 2021105592

(51) Int. Cl. A01K 11/00; A01K 29/00; G01S 19/07; G01S 19/19; G01S 19/43

(52) U.S. Cl. CPC A01K 11/008; A01K 29/005; G01S 19/073; G01S 19/19; G01S 19/43

(57) ABSTRACT

A tracking system and method for animal racing and/or training. The system comprises at least one RTK base station installed at or near a racecourse and/or training track and configured for generating calibrated GPS/GNSS data indicating a fixed location of the RTK base station and for obtaining current GPS/GNSS data of the RTK base station; one or more TAG modules configured for being moveable with respective ones of the animals along the race course and/or training track, each TAG module configured for obtaining current GPS/GNSS data of the TAG module; and a processor unit configured for generating output tracking data based on the current GPS/GNSS data of the respective TAG modules and correction data generated from the calibrated GPS/GNSS data and the current GPS/GNSS data of the RTK base station; wherein each tag module is configured for transmitting position data based on the current GPS/GNSS data of the tag module via the mobile network to the processing unit.

### FIELD OF INVENTION

The present invention relates broadly to a tracking system and method for animal racing and/or training.

### BACKGROUND

Any mention and/or discussion of prior art throughout the specification should not be considered, in any way, as an admission that this prior art is well known or forms part of common general knowledge in the field.

In animal racing and training, specifically for thoroughbred, harness and greyhound racing and training, existing systems track the animals using Global Positioning System (GPS) and/or Global navigation satellite system (GNSS) technology, for example for positions and rankings during races and performance monitoring during training.

Amongst the GPS based systems, the Real-Time Kinematic GPS (RTK-GPS) based tracking system is an enhancement of the regular satellite-based positioning technology, known as GPS/GNSS tracking. Specifically, in regular GPS/GNSS tracking, by the time the satellite signals reach a tag module (i.e. a mobile small sized GPS unit, sometimes also referred to as a transponder) on the animal, jockey, driver, sulky or lure, different sources contribute inaccuracies such as the atmosphere layers. The RTK-GPS tracking system corrects these variable errors through a permanently installed Real-Time Kinematic (RTK) base station at or near the racecourse or training tracks, which can be connected via cable or a WiFi connection to a processor unit. The processor unit transmits processed data to TV, video, apps, result websites, or any other applications on the internet or via a local network.

In knowing the exact location of the RTK base station, satellite data variations can be calculated instantly resulting in correction data being emitted continuously to the tag module. Hence, positions and rankings associated with the tag module can be determined in real-time down to cm accuracy.

In addition to the RTK base station, multiple relay transceivers typically extend the coverage to the tag modules along the racecourse or training tracks. The real-time transmission of the correction data to the mobile tag modules is done using radio technology such as WiFi or other wireless transmissions. Each tag module transmits the corrected satellite-based position via the radio technology to the processor unit for information processing. The timely delivery of the correction data to the tag module and the corrected satellite-based position back to the processor unit is critical to achieve a high level of accuracy.

Due to the complexity of the infrastructure in existing RTK-GPS based tracking systems for animal racing and/or training, the tag module position information is travelling via the local network and attached infrastructure for up to 0.5 s before being processed for display on the TV or other media outlets.

In addition, complex communication links between tag modules and the relay transceivers (e.g. 900 MHz network) and in the wireless local area network to the processor unit can be the cause of communication failure resulting in performance issues, no data connectivity, service delivery and high costs to the client/users.

Embodiments of the present invention seek to address at least one of the above problems.

### SUMMARY

In accordance with a first aspect of the present invention, there is provided a tracking system for animal racing and/or training comprising:
at least one RTK base station installed at or near a racecourse and/or training track and configured for generating calibrated GPS/GNSS data indicating a fixed location of the RTK base station and for obtaining current GPS/GNSS data of the RTK base station;
one or more tag modules configured for being moveable with respective ones of the animals along the race course and/or training track, each tag module configured for obtaining current GPS/GNSS data of the tag module; and
a processor unit configured for generating output tracking data based on:
   the current GPS/GNSS data of the respective tag modules; and
   correction data generated from the calibrated GPS/GNSS data and the current GPS/GNSS data of the RTK base station;
wherein each tag module is configured for transmitting position data based on the current GPS/GNSS data of the tag module via the mobile network to the processing unit.

In accordance with a second aspect of the present invention, there is provided a tracking method for animal racing and/or training, the method comprising the steps of:
using at least one RTK base station installed at or near a racecourse and/or training track and configured for generating calibrated GPS/GNSS data indicating a fixed location of the RTK base station and for obtaining current GPS/GNSS data of the RTK base station;
providing one or more tag modules configured for being moveable with respective ones of the animals along the race course and/or training track;
using each tag module for obtaining current GPS/GNSS data of the tag module; and
using a processor unit for generating output tracking data based on:
   the current GPS/GNSS data of the respective tag modules; and
   correction data generated from the calibrated GPS/GNSS data and the current GPS/GNSS data of the RTK base station;
and transmitting position data based on the current GPS/GNSS data of the tag module via the mobile network to the processing unit.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic drawing illustrating a tracking system for animal racing or training, according to an example embodiment.

FIG. 2 shows a schematic diagram of a tag module of the tracking system of FIG. 1.

FIG. 3 shows a flowchart illustrating a tracking method for animal racing and/or training, according to an example embodiment.

### DETAILED DESCRIPTION

Embodiments of the present invention can provide a tracking system for animal racing and/or training with simplified infrastructure while maintaining reliability, by deployment of mobile network communication links between RTK base station(s), tag module(s) and a Processor Unit.

In an example embodiment, the tag module, RTK base station and the processor unit, for example in the form of one or more computer(s), which can be implemented locally and/or in cloud-based computing, are connected to each other via a mobile network such as, but not limited to, the 5G mobile network or future advanced mobile network(s), hereinafter also referred to as “at least 5G technology”, to improve transmission delays, whilst reducing the connectivity complexities and reducing a loss of data transmission. This also reduces costs associated with existing local infrastructure on a typical racecourse/training track.

In an example embodiment, each tag module communicates directly to the processor unit via the 5G mobile network. This processor unit can be placed within the venue, centralized or can be cloud based. Each tag module then receives all the RTK correction data without having to rely on local infrastructure, advantageously resulting in the reduction of connection hopping between the various components.

The following description describes the system and its components in a simplified manner addressed to a person skilled in the art.

Generally, a tag module for use in an example embodiment is a device which is moveable with the animal by being, for example, attached to the animal and/or jockey and/or sulky and/or driver during the race or training regime. The tag module's purpose is to receive and transmit data wirelessly. The data can include, but is not limited to, position data, motion data, control signal data and/or other data collected from the tag module's placement.

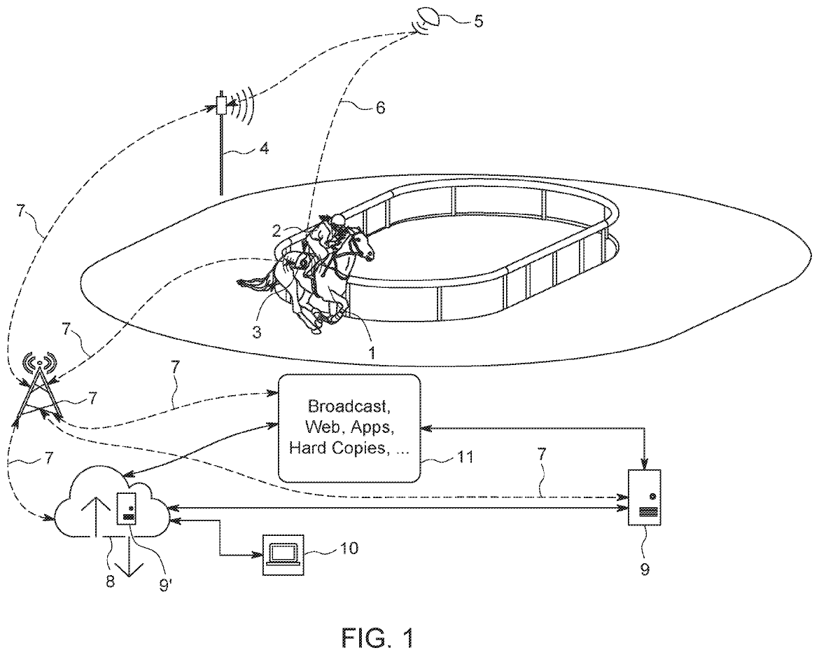

FIG. 1 shows a tracking system for animal racing and/or training according to an example embodiment in which a fixedly installed RTK base station (4) receives GPS/GNSS data from multiple GPS/GNSS Satellites (5). Because the actual position of the RTK base station (4) is known, the RTK base station (4) generates correction data accounting for inaccuracies such as caused by the atmosphere layers and sends the correction data to the Processor Unit (9) via the mobile network (7), e.g. in the form of a 5G mobile network. Specifically, in this example embodiment the RTK base station (4) obtains calibrated GPS/GNSS data indicating the fixed location of the RTK base station during a calibration mode, and receives current GPS/GNSS data indicating the fixed location of the RTK base station received from a GPS/GNSS satellite, which can vary due to inaccuracies such as the atmosphere layers, during a correction data generation mode, as is understood in the art.

In this example embodiment, the Processor Unit (9) transmits the correction data to the tag module(s) (3) on the animal (1), here a horse, via the mobile network (7). As mentioned above, the tag module (3) can be attached to the animal (1) and/or jockey (2) and/or sulky and/or driver during the race or training regime.

Each of the Processor Unit (9), the RTK base station (4) and the tag modules (3) are configured to communicate via the mobile network (7) using respective network interfaces such as a subscriber identification module (SIM) card or eSIM.

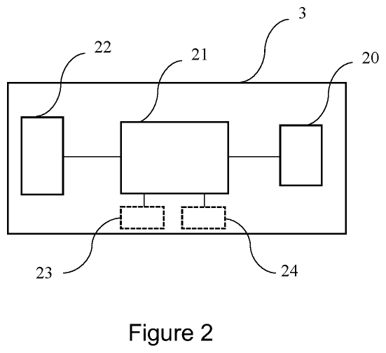

With reference to FIG. 2, each tag module (3) comprises a GPS/NSS receiver (20) for receiving its GPS/GNSS data from multiple GPS/GNSS Satellites (5, FIG. 1), which is subjected to inaccuracies such as caused by the atmosphere layers. Furthermore, in this example embodiment each tag module (3) uses a processing element (21) such as a computer chip to calculate it's position data based on the GPS/GNSS data received from the Satellites (5, FIG. 1) and based on the correction data from the RTK base station (4, FIG. 1) received via the Processor Unit (9, FIG. 1) or directly from the RTK base station (4, FIG. 1), using a 5G mobile network interface (22) such as SIM card or eSIM. Each tag module (3) transmits its position data to the Processor Unit (9, FIG. 1) via the 5G mobile network interface (22) (compare mobile network 7, in FIG. 1). It is noted that in another example embodiment, the Processor Unit (9, FIG. 1) can perform the correction calculations based on the “raw” GPS/GNSS data information received from the tag module(s) (3) and correction data received from the RTK base station (4), or the processing can be done jointly by the tag module(s) (3) and the Processor Unit (9, FIG. 1).

In various example embodiments, the tag module(s) (3) can be further equipped with one or more sensors, such as, but not limited to, motion sensor(s) (23), in order to provide data pertaining to the animal and/or jockey, for example data representing information relating to Stride Rate, Heart Rate information and any other motion data pertaining to the animal and/or jockey during an event. Additionally or alternatively, the tag module(s) (3) can be equipped with one or more receivers (24), such as, but not limited to, a Bluetooth receiver, in order to receive data pertaining to the animal and/or jockey, for example data representing information relating to Stride Rate, Heart Rate information and any other motion data pertaining to the animal and/or jockey during an event.

Such information can be processed within the tag module(s) (3) using the processing element (21) and/or additional dedicated processing element(s). It is noted that in other example embodiments, the Processor Unit (9, FIG. 1) can perform the processing of the information received from the tag module(s) (3), or the processing can be done jointly by the tag module(s) (3) and the Processor Unit (9, FIG. 1). Each tag module (3) according to an example embodiment is a small sized mobile unit which is configured to be moveable with the animal, e.g. to be carried by the animal in a pocket in the saddlecloth, number vest or jockey vest. While the requirements to the tag modules (3) are racing/training specific, a high grade of robustness and reliability is preferably provided by way of its specifications such as casing material choice, internal component choice and internal packaging. Furthermore, a small sized form factor is preferred, while being able to achieve a high accuracy.

Returning to FIG. 1, the Processor Unit (9) can be implemented on-premise, placed on or off-course, and/or can be implemented cloud based, indicated as Processing Unit (9′), accessible via Internet (8) in various example embodiments. In an example embodiment in which the Processing Unit (9′) is cloud based, a computer (10) may be used to interface with the Processing Unit (9′). It is noted that data exchange between the Processor Unit (9′) and each tag module (3) via the mobile network (7) may include using the mobile network (7) for the last communication link, e.g. between a mobile network base station (12) and each tag module 3.

The Processor Unit (9, 9′) transmits processed data to TV, video, apps, result websites, or any other applications to Clients and Users (11), e.g. via the Internet (8), and/or via the mobile network (7), and/or via a local network. The Clients and Users (11), the computer (10) and the Processor Unit (9) can each be connected to the Internet (8) through various technologies such as NBN, Fibre, the mobile network (7), or other modes available at the time, in various example embodiments.

In the example embodiment described above with reference to FIG. 1, data exchange between the Processing Unit (9) and the RTK base station (4) is implemented via the mobile network (7). However, the data exchange can be implemented in different ways in different example embodiments, including radio technology such as WiFi or other wireless transmissions, the internet, or wired (network-) connections.

An example embodiment of the present invention can provide the advantage that Clients and User (11) can receive the data with the lowest possible delay which enable future additional client experience and betting opportunities.

An example embodiment of the present invention can reduce costs otherwise associated with local infrastructure on a typical racecourse/training track.

An example embodiment of the present invention can allow to use one fixed RTK base station (4) for multiple racecourses and/or training tracks as long as they are within a specific radius of the RTK base station (4) such that the correction data is applicable to the multiple racecourse and/or training tracks.

An example embodiment of the present invention can eliminate the need for relay transceivers along the racecourses and/or training tracks.

In one embodiment, a tracking system for animal racing and/or training is provided, comprising at least one RTK base station installed at or near a racecourse and/or training track and configured for generating calibrated GPS/GNSS data indicating a fixed location of the RTK base station and for obtaining current GPS/GNSS data of the RTK base station; one or more tag modules configured for being moveable with respective ones of the animals along the race course and/or training track, each tag module configured for obtaining current GPS/GNSS data of the tag module; and a processor unit configured for generating output tracking data based on the current GPS/GNSS data of the respective tag modules and correction data generated from the calibrated GPS/GNSS data and the current GPS/GNSS data of the RTK base station; wherein each tag module is configured for transmitting position data based on the current GPS/GNSS data of the tag module via the mobile network to the processing unit.

Each tag module may be configured for transmitting position data based on the current GPS/GNSS data of the tag module via the mobile network to the processing unit.

The RTK base station may be configured for transmitting the correction data to the tag modules via the mobile network, and each tag module may be configured to generate the position data based on the current GPS/GNSS data of the tag module and the correction data.

The processor unit may be configured for transmitting the correction data to the tag modules via the mobile network, and each tag module may be configured to generate the position data based on the current GPS/GNSS data of the tag module and the correction data.

The processor unit may be configured for receiving the current GPS/GNSS data as the position data from the tag modules and to generate corrected position data of the tag modules based on the current GPS/GNSS data and the correction data.

The RTK base station, the tag modules and the processor unit may be configured for data exchange via the mobile network and the internet.

Preferably, the mobile network is based on at least 5G technology.

The processor unit may be implemented on-premise, and/or can be implemented cloud based.

Each tag module may be configured to be moveable with the animal by being attachable to one or more of a group consisting of the animal, jockey, sulky, and driver.

Each tag module may comprise at least one sensor for providing additional data pertaining to the animal and/or jockey.

Each tag module may comprise a receiver for receiving additional data pertaining to the animal and/or jockey from one or more external devices.

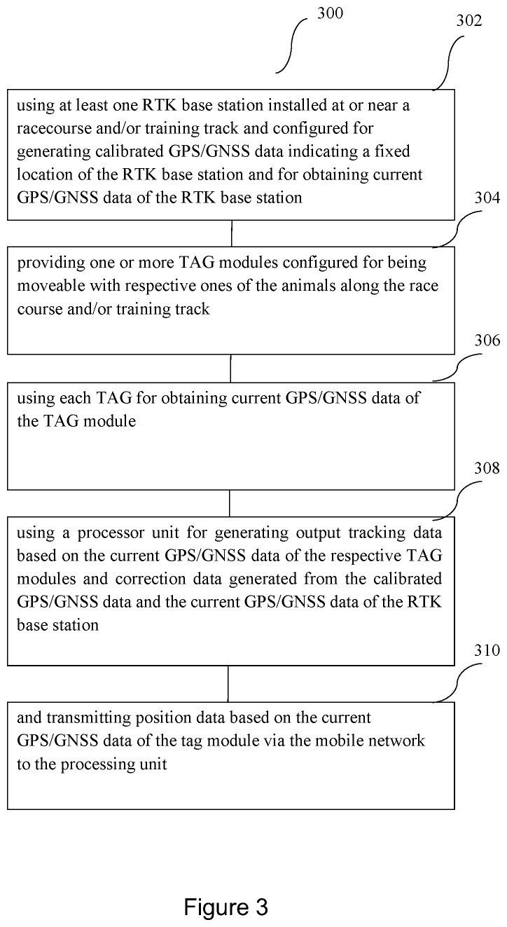

FIG. 3 shows a flowchart 300 illustrating a tracking method for animal racing and/or training. At step 302, at least one RTK base station installed at or near a racecourse and/or training track is used for generating calibrated GPS/GNSS data indicating a fixed location of the RTK base station and for obtaining current GPS/GNSS data of the RTK base station. At step 304, one or more tag modules configured for being moveable with respective ones of the animals along the race course and/or training track are provided. At step 306, each tag module is used for obtaining current GPS/GNSS data of the tag module. At step 308, a processor unit is used for generating output tracking data based on the current GPS/GNSS data of the respective tag modules and correction data generated from the calibrated GPS/GNSS data and the current GPS/GNSS data of the RTK base station. At step 310, position data based on the current GPS/GNSS data of the tag module is transmitted via the mobile network to the processing unit.

The method may comprise transmitting position data based on the current GPS/GNSS data of the tag module via the mobile network to the processing unit.

The method may comprise using the RTK base station to generate the correction data and to transmit the correction data to the tag modules via the mobile network, and using each tag module to generate the position data based on the current GPS/GNSS data of the tag module and the correction data.

The method may comprise using the processor unit to transmit the correction data to the tag modules via the mobile network, and using each tag module to generate the position data based on the current GPS/GNSS data of the tag module and the correction data.

The method may comprise using the processor unit to receive the current GPS/GNSS data as the position data from the tag modules and to generate corrected position data of the tag modules based on the current GPS/GNSS data and the correction data.

The RTK base station, the tag modules and the processor unit may be configured for data exchange via the mobile network and the internet.

The mobile network may be based on at least 5G technology.

The processor unit may be implemented on-premise, and/or can be implemented cloud based.

The tag modules may be configured to be moveable with the animal by being attachable to one or more of a group consisting of the animal, jockey, sulky, and driver.

The method may comprise using at least one sensor of each tag module for providing additional data pertaining to the animal and/or jockey.

Each tag module may comprise a receiver and the method may comprise receiving additional data pertaining to the animal and/or jockey from one or more external devices using the receiver.

Aspects of the systems and methods described herein, such as the RTK base station (4), the Processor Unit (9. 9′), the tag module(s) (3) and the computer (10) may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A tracking system for animal racing and/or training comprising:
at least one RTK base station installed at or near a racecourse and/or training track and configured for generating calibrated GPS/GNSS data indicating a fixed location of the RTK base station and for obtaining current GPS/GNSS data of the RTK base station;
one or more tag modules configured for being moveable with respective ones of the animals along the race course and/or training track, each tag module configured for obtaining current GPS/GNSS data of the tag module; and
a processor unit configured for generating output tracking data based on:
the current GPS/GNSS data of the respective tag modules; and
correction data generated from the calibrated GPS/GNSS data and the current GPS/GNSS data of the RTK base station;
wherein each tag module is configured for transmitting position data based on the current GPS/GNSS data of the tag module via the mobile network to the processing unit using a mobile network interface of the tag module.

2. The system of claim 1, wherein the RTK base station is configured for generating the correction data and for transmitting the correction data to the tag modules via the mobile network, and each tag module is configured to generate the position data based on the current GPS/GNSS data of the tag module and the correction data.

3. The system of claim 1, wherein the processor unit is configured for transmitting the correction data to the tag modules via the mobile network, and each tag module is configured to generate the position data based on the current GPS/GNSS data of the tag module and the correction data.

4. The system of claim 1, wherein the processor unit is configured for receiving the current GPS/GNSS data as the position data from the tag modules via the mobile network and to generate corrected position data of the tag modules based on the current GPS/GNSS data and the correction data.

5. The system of claim 1, wherein the RTK base station, the tag modules and the processor unit are configured for data exchange via the mobile network and the internet.

6. The system of claim 1, wherein the mobile network is based on at least 5G technology.

7. The system of claim 1, wherein the processor unit is implemented on-premise, and/or can be implemented cloud based.

8. The system of claim 1, wherein each tag module is configured to be moveable with the animal by being attachable to one or more of a group consisting of the animal, jockey, sulky, and driver.

9. The system of claim 1, wherein each tag module comprises at least one sensor for providing additional data pertaining to the animal and/or jockey.

10. The system of claim 1, wherein each tag module comprises a receiver for receiving additional data pertaining to the animal and/or jockey from one or more external devices.

11. A tracking method for animal racing and/or training, the method comprising the steps of:
using at least one RTK base station installed at or near a racecourse and/or training track and configured for generating calibrated GPS/GNSS data indicating a fixed location of the RTK base station and for obtaining current GPS/GNSS data of the RTK base station;
providing one or more tag modules configured for being moveable with respective ones of the animals along the race course and/or training track;
using each tag module for obtaining current GPS/GNSS data of the tag module;
using a processor unit for generating output tracking data based on:
the current GPS/GNSS data of the respective tag modules; and
correction data generated from the calibrated GPS/GNSS data and the current GPS/GNSS data of the RTK base station;
and transmitting position data based on the current GPS/GNSS data of the tag module via the mobile network to the processing unit using a mobile network interface of the tag module.

12. The method of claim 11, comprising using the RTK base station to generate the correction data and to transmit the correction data to the tag modules via the mobile network, and using each tag module to generate the position data based on the current GPS/GNSS data of the tag module and the correction data.

13. The method of claim 11, comprising using the processor unit to transmit the correction data to the tag modules via the mobile network, and using each tag module to generate the position data based on the current GPS/GNSS data of the tag module and the correction data.

14. The method of claim 11, comprising using the processor unit to receive the current GPS/GNSS data as the position data from the tag modules via the mobile network and to generate corrected position data of the tag modules based on the current GPS/GNSS data and the correction data.

15. The method of claim 11, wherein the RTK base station, the tag modules and the processor unit are configured for data exchange via the mobile network and the internet.

16. The method of claim 11, wherein the mobile network is based on at least 5G technology.

17. The method of claim 11, wherein the processor unit is implemented on-premise, and/or can be implemented cloud based.

18. The method of claim 11, wherein the tag modules are configured to be moveable with the animal by being attachable to one or more of a group consisting of the animal, jockey, sulky, and driver.

19. The method of claim 11, comprising using at least one sensor of each tag module for providing additional data pertaining to the animal and/or jockey.

20. The method of claim 11, wherein each tag module comprises a receiver and the method comprises receiving additional data pertaining to the animal and/or jockey from one or more external devices using the receiver.
